(19) United States
(12) Patent Application Publication
(10) Pub. No.: US 2026/0183834 A1
(43) Pub. Date: Jul. 2, 2026

(54) APPARATUS FOR PRODUCING A METALLIC PRODUCT AND USE OF AN APPARATUS

(71) Applicant: SMS group GmbH, Mönchengladbach (DE)

(72) Inventors: Stephan FELDHAUS, Uster (CH); Andrea LANARI, Tarcento (IT); Marco ABRAM, Zürich (CH); Michael KÖBERICH, Hückelhoven (DE); Thomas MASSMANN, Übach-Palenberg (DE)

(21) Appl. No.: 19/129,571

(22) PCT Filed: Nov. 2, 2023
(86) PCT No.: PCT/EP2023/080533

§ 371 Date: May 13, 2025

(30) Foreign Application Priority Data
Nov. 14, 2022 (DE) 10 2022 130 091.9

(51) Int. Cl. B22D 11/12; B22D 11/14; H05B 11/00

(52) U.S. Cl. CPC B22D 11/1206; B22D 11/142; H05B 11/00

(57) ABSTRACT

An apparatus for producing a metallic product, in particular for producing a metallic long product, in particular for producing a metallic bar and/or a metallic wire, in particular a metallic product of an iron-based alloy, the apparatus includes an electric arc furnace for producing a molten metal from a metallic raw material; a continuous caster for producing a billet strand from the molten metal; and a rolling plant for forming the billet strand into the metallic product; wherein the apparatus is set up to reduce a sum of scope 1 CO2 emissions and scope 2 CO2 emissions, in particular the apparatus includes a sum of scope 1 CO2 emissions and scope 2 CO2 emissions of less than or equal to 300 kg/t of the metallic product, preferably less than or equal to 275 kg/t and particularly preferably less than or equal to 250 kg/t.

The present invention relates to an apparatus for producing a metallic product and a use, in particular a use of the apparatus for producing a metallic product.

In the production of metallic products, especially in the production of metallic long products, it is known to provide process energy by burning carbon-containing gases, which results in CO₂ emission.

Furthermore, it is known to cut the minimum one billet strand produced during continuous casting of a metallic product, in particular during continuous casting of a metallic long product, into individual billets, to allow these to cool to room temperature and to roll them, previously reheated, in a rolling plant into steel rod, steel wire and other steel long products.

For reheating the billets, it is known to heat them up in a furnace by burning a carbon-containing gas, so that this also produces CO₂ emissions.

The invention is based on the task of providing the state of the art with an improvement or an alternative.

According to a first aspect of the invention, the task is solved by an apparatus for producing a metallic product, in particular for producing a metallic long product, in particular for producing a metallic bar and/or a metallic wire, in particular a metallic product of an iron-based alloy, comprising:
an electric arc furnace for producing a molten metal from a metallic raw material;
a continuous caster for producing a billet strand from the molten metal; and
a rolling plant for forming the billet strand into the metallic product;
   wherein the apparatus is set up to reduce a sum of scope 1 CO₂ emissions and scope 2 CO₂ emissions, in particular wherein the apparatus comprises a sum of scope 1 CO₂ emissions and scope 2 CO₂ emissions of less than or equal to 300 kg/ton of the metallic product, preferably less than or equal to 275 kg/ton and particularly preferably less than or equal to 250 kg/ton.

The following terms are explained in more detail:
First of all, it should be expressly pointed out that in the context of this patent application indefinite articles and figures such as “one”, “two”, etc. should normally be understood as “at least” information, i.e. “at least one . . . ” , “at least two . . . ” etc., unless it is expressly apparent from the respective context or it is obvious or technically mandatory for the person skilled in the art that only “exactly one . . . ” , “exactly two . . . ” , etc. can be meant.

In the context of this patent application, the term “in particular” should always be understood as meaning that this term introduces an optional, preferential feature. The expression is not to be understood as “namely”.

An “apparatus for producing a metallic product”, in particular for producing a metallic long product, is understood to be an apparatus configured for producing a molten metal, continuous casting of a billet strand, also called strand casting, and rolling the billet strand into the metallic product, in particular a steel product.

The apparatus for producing a metallic product may have a nominal casting speed of more than 3 m/min, preferably more than 5 m/min and particularly preferably more than 7 m/min. The apparatus for producing a metallic product may have a nominal casting speed of less than 10 m/min.

The apparatus for producing a metallic product may have a section size for billets with a cross section of more than 10,000 mm², preferably more than 20,000 mm² and particularly preferably more than 30,000 mm. Preferably the apparatus for producing a metallic product may have a section size for billets with a cross section of more than 35,000mm², preferably more than 40,000 mm² and particularly preferably more than 45,000 mm². The apparatus for producing a metallic product may have a section size for billets with a cross section of less than 50,000 mm².

Advantageously, the apparatus for producing a metallic product may have an electric arc furnace for producing a molten metal from a metallic raw material.

An “electric arc furnace” is a furnace that uses electric energy provided and/or treated by an energy supply apparatus to generate an electric arc to melt a metallic raw material, particularly scrap metal and/or a scrap metal mix and/or direct reduced iron (DRI) and/or hot briquetted iron (HBI) and/or hot metal and/or flux materials, in the electric arc furnace.

In particular, a can be used for steel production.

The electric arc forms between the metallic raw material and the electrode. The charge of the electric are furnace is heated both by current passing through the metallic raw material and by the radiant energy evolved by the arc. The electric arc temperature can reach around 3.000° C. or higher.

An electric arc furnace can have a charge capacity greater than or equal to 1 ton, preferably greater than or equal to 20 ton, and particularly preferably greater than or equal to 50 ton. Further advantageously, an electric arc furnace can have a charge capacity greater than or equal to 100 ton, preferably greater than or equal to 200 ton, and particularly preferably greater than or equal to 400 ton.

The electric arc furnace may be further adapted to produce a desired alloy in terms of secondary metallurgical treatment steps. Alternatively, the desired alloy can be produced by secondary metallurgy in a ladle following the electric arc furnace in terms of material flow.

After setting the alloy, in particular by alloying and degassing, and arriving at the desired temperature, the apparatus for producing a metallic product is adapted to transport the molten metal to the top of the continuous caster, in particular by making use of a ladle filled with the molten metal.

A “continuous caster” is understood as a device featuring an open-base mold to shape a billet strand, in particular a continuous billet strand, preferably a turning zone for redirecting the billet strand horizontally if necessary and a withdrawal unit to control and/or regulate the casting speed.

Furthermore the apparatus for producing a metallic product may feature a “rolling plant” adapted to form the billet strand into the metallic product by passing through one or more pairs of rolls adapted to reduce the thickness, to make the thickness uniform, and/or to impart a desired mechanical property.

After forming the metallic product by the rolling plant, the apparatus for producing a metallic product may have a coiler that is set up to coil up the metallic product. If a coiler is used, CO₂ emissions, in particular scope 2 CO₂ emissions, can be reduced by providing the coiler with an electric drive that can recuperate electrical energy into the supply network when the winder is decelerated.

When winding the metallic product, the metallic product has a temperature of higher than or equal to 780° C., preferably higher than or equal to 850° C. and particularly preferably higher than or equal to 930° C. Preferably, the metallic product has a temperature during winding of less than or equal to 1.100° C., preferably less than or equal to 1.000° C. and particularly preferably less than or equal to 950° C. When winding the metallic product into a coil and/or after winding the metallic product into a coil, the waste heat of the metallic product and/or the coil can be recovered, thus reducing the CO₂ emission.

Among other things, a cover for the coil is being considered under which the waste heat accumulates and can be used for conversion in a heat exchanger.

“Scope 1 CO₂ emission” is understood to be a direct CO₂ emission that is associated directly with fossil fuel combustion in the perimeters of the apparatus for producing a metallic product.

“Scope 2 CO₂ emission” is understood to be an indirect CO₂ emission that is associated with the purchase of electricity, steam, heat and/or cooling.

The apparatus for producing a metallic product may be adapted to produce a metallic bar and/or a metallic wire, in particular a metallic product of an iron-based alloy.

An apparatus for producing a metallic product can comprise a sum of scope 1 CO₂ emissions and scope 2 CO₂ emissions of less than or equal to 325 kg/ton of the metallic product, preferably less than or equal to 262 kg/ton of the metallic product, and particularly preferably less than or equal to 230 kg/ton of the metallic product. Further advantageously, an apparatus for producing a metallic product can comprise a sum of scope 1 CO₂ emissions and scope 2 CO₂ emissions of less than or equal to 220 kg/ton of the metallic product, preferably less than or equal to 210 kg/ton of the metallic product, and particularly preferably less than or equal to 200 kg/ton of the metallic product.

Here, an apparatus for producing a metallic product is proposed whose CO₂ emissions, especially the sum of scope 1 CO₂ emissions and scope 2 CO₂ emissions, are reduced compared to a previously known apparatus for producing a metallic product, in particular in comparison to a traditional mini mill for producing metallic long products.

Preferably, the apparatus comprises a scope 1 CO₂ emission of less than or equal to 175 kg/ton of the metallic product, preferably less than or equal to 140 kg/ton and particularly preferably less than or equal to 70 kg/ton.

An apparatus for producing a metallic product can comprise a scope 1 CO₂ emission of less than or equal to 160 kg/ton of the metallic product, preferably less than or equal to 120 kg/ton of the metallic product, and particularly preferably less than or equal to 100 kg/ton of the metallic product. Further advantageously, an apparatus for producing a metallic product can comprise a scope 1 CO₂ emission of less than or equal to 90 kg/ton of the metallic product, preferably less than or equal to 80 kg/ton of the metallic product, and particularly preferably less than or equal to 60 kg/ton of the metallic product.

In an optional embodiment, the apparatus comprises a scope 2 CO₂ emission of less than or equal to 160 kg/ton of the metallic product, preferably less than or equal to 150 kg/ton and particularly preferably less than or equal to 140 kg/Con.

An apparatus for producing a metallic product can comprise a scope 2 CO₂ emission of less than or equal to 130 kg/ton of the metallic product, preferably less than or equal to 120 kg/ton of the metallic product, and particularly preferably less than or equal to 110 kg/ton of the metallic product. Further advantageously, an apparatus for producing a metallic product can comprise a scope 2 CO₂ emission of less than or equal ton 100 kg/ton of the metallic product, preferably less than or equal to 90 kg/ton of the metallic product, and particularly preferably less than or equal to 80 kg/ton of the metallic product.

If energy is supplied to the apparatus for producing a metallic product by means of electricity instead of fossil fuels, in particular by heating a furnace for melting down the metallic raw material with electrical energy instead of by burning a gas containing carbon, the scope 1 CO₂ emission can be reduced. Similarly, however, the scope 2 CO₂ emission can increase if the electrical energy is also generated by burning fossil fuels in a power plant located outside the apparatus for producing a metallic product.

There are two independent starting points for reducing the scope 2 CO₂ emission.

On the one hand, the conversion efficiency of the energy within the apparatus for producing a metallic product can be improved by technical measures so that the energy is preserved as far as possible.

On the other hand, the electrical energy can be obtained from energy sources that have only a low CO₂ footprint, in particular by means of nuclear energy, or which are regenerative, in particular hydro energy, wind energy, bio energy and/or solar energy.

Preferably, the apparatus for producing a metallic product is directly connected via a power supply, in particular a three-phase AC power supply network and/or via a DC power supply, to a wind farm and/or a biogas plant and/or a hydroelectric power plant and/or a photovoltaic plant and can obtain the electrical energy from there.

In an expedient embodiment, the electric arc furnace comprises an energy supply apparatus for supplying the electric arc furnace with electrical energy;
wherein the energy supply apparatus is connected to a three-phase power supply system;
wherein said energy supply apparatus being connected to at least one anode and one cathode for supplying said electric arc furnace with a direct current or to at least two electrodes for supplying said electric arc furnace with a alternating current; and
wherein the energy supply apparatus comprises a phase-shifting transformer and a rectifier circuit.

In an alternative embodiment, the electric arc furnace comprises an energy supply apparatus for supplying the electric arc furnace with electrical energy;
wherein the energy supply apparatus is connected to a three-phase power supply system;
wherein said energy supply apparatus being connected to at least two electrodes for supplying said electric arc furnace with an alternating current;
wherein the energy supply apparatus comprises at least one single phase power transformer.

The following terms are explained in more detail:
An “energy supply apparatus” is understood to be an apparatus arranged to provide electrical power, to condition electrical power, and/or to mitigate power system perturbations. An energy supply apparatus could electrically be connected to an electric arc furnace or to a power transformer which is connected to the electric arc furnace.

An energy supply apparatus can feature a transformer, in particular a phase-shifting transformer and a rectifier. In addition, an energy supply apparatus may have a smoothing circuit adapted to straighten a ripple voltage, wherein the smoothing circuit can feature a capacity bank connected in parallel to an electrical load and/or an inductance bank connected in series to the electrical load, and an inverter to power an AC-powered electric are furnace or a chopper to power an DC-powered electric arc furnace.

In an electric arc furnace operated by direct current, the electrodes may be referred to as anode and cathode. An anode can also be divided into several segments.

An anode, preferably a bottom electrode, is metallic and/or conductive material in the bottom of a furnace and arcs are formed between the metallic raw material and the cathode from top, preferably a cathode made of graphite or carbon.

In an electric arc furnace operated by alternating current, the at least two electrodes are preferably made of graphite or carbon.

A “phase-shifting transformer” is a specialized type of transformer, which can be configured to adjust the phase relationship between its primary circuits (primary) and its secondary circuits (secondary), which allows to control the power flow on a three-phase power supply system.

The phase angle of a three-phase transformer is a function of a vector group of the three-phase transformer.

A vector group, elsewhere defined by a connection symbol, is the International Electrotechnical Commission (IEC) method of categorizing primary winding, preferably high voltage (HV) winding, and secondary winding, preferably low voltage (LV) winding, configurations of three-phase transformers. The vector group designation indicates the windings configurations and the difference in phase angle between them.

A vector group provides a simple way of indicating how the connections of a transformer are arranged. Different configurations are possible as to how the primary windings, preferably MV windings, and the secondary windings, preferably LV windings, are connected to each other. In particular, they can be connected to each other in a delta circuit, a star circuit or a zigzag circuit, whereby primary windings, preferably MV windings, and secondary windings, preferably LV windings, can each be connected differently, resulting in a phase-shift between the primary side and the secondary side of the phase-shifting transformer.

For example, a star MV winding and a delta IV winding may be combined to form a vector group and will result in a 30-degree phase-shift between the primary side and the secondary side.

By advantageous selection of the vector group, the total harmonic distortion injected in the power supply system can be minimized.

The total harmonic distortion of the three-phase power supply system can be influenced by selecting the vector group of the three-phase transformer. In particular, the total harmonic distortion caused in the three-phase power supply system can be minimized by using a phase-shifting transformer.

The phase angle can be influenced by the phase-shifting transformer in a range of less than or equal to plus/minus 5° primary to secondary phase shift, preferably in a range of less than or equal to plus/minus 10° and particularly preferably in a range of less than or equal to plus/minus 15°. Furthermore, the phase angle can preferably be influenced by the phase-shifting transformer in a range of less than or equal to plus/minus 20° primary to secondary phase shift, preferably in a range of less than or equal to plus/minus 25° and particularly preferably in a range of less than or equal to plus/minus 30°. Furthermore, the phase angle can preferably be influenced by the phase-shifting transformer in a range of less than or equal to plus/minus 35° primary to secondary phase shift, preferably in a range of less than or equal to plus/minus 40° and particularly preferably in a range of less than or equal to plus/minus 45° primary to secondary phase shift. The above phase shift values are to be understood as being read between the closest adjacent upper or lower re-versal points of the AC waveforms of the primary and the phase shifted secondary.

A phase-shifting transformer is a simple, robust and reliable technology.

A “rectifier” is an electrical device that converts alternating current, which periodically reverses direction, to direct current, which flows in only one direction. A rectifier can be a three-phase rectifier.

The rectifier can have a topology comprising and/or consisting of diodes. A three-phase diode rectifier can be an uncontrolled n times 6 pulse diode rectifier, in particular a 6 pulse diode rectifier, a 12 pulse diode rectifier, a 18 pulse diode rectifier and so on. The three phase diode rectifier allows energy flowing only from the network to the furnace.

The rectifier can have a topology comprising and/or consisting of thyristors. A three-phase thyristor rectifier can be a controlled thyristor rectifier, in particular a 6 pulse thyristor rectifier, a 12 pulse thyristor rectifier, a 18 pulse thyristor rectifier and so on. The three phase thyristor rectifier allows energy flowing only from the network to the furnace.

The rectifier can have a topology comprising and/or consisting of IGBTs. A three-phase IGBT rectifier can be a controlled IGBT rectifier. The three phase IGBT rectifier allows energy flowing from the network to the furnace and to the furnace to the network. The three phase IGBT rectifier is widely known as reversible rectifier or AFE (Active Front End).

The use of an electric are furnace, in particular a DC-powered electric are furnace or a AC-powered electric arc furnace, Can reduce the scope 1 CO₂ emission compared to a fossil fuel-fired furnace for melting down the metallic raw material.

An electric arc furnace represents a highly nonlinear load. Such nonlinear load can cause flicker and/or harmonic distortion in the power supply system connected to the electric arc furnace.

The energy supply apparatus can include one or more sensors to provide information about harmonic distortions and/or flicker and/or a ratio of active power flow and reactive power flow in the power supply system.

An electronic control unit can be I operatively connected to one or more such sensors and can receive sensor signals, process them, and use them to control or regulate the energy supply apparatus, in particular by control and/or regulation interventions on the inverter or the chopper.

The reduction in harmonic distortion and/or flicker that can be achieved with this can mean that the apparatus for producing a metallic product can dispense with a static reactive power (VAR) compensator to supply the EAF. This can reduce investment costs and increase electrical efficiency, thereby reducing the scope 2 CO₂ emission.

If the electric arc furnace is set up for DC or AC operation, so that the electric supply apparatus can dispense with an inverter, the electrical efficiency of the overall system can be improved once again.

### It Has Been Shown That the Energy Supply Apparatus Proposed

herein in combination with a DC operated electric arc furnace or with a AC operated electric arc furnace can reduce the necessary electric energy consumption associated with the operation of the electric are furnace by more than or equal to 5%, preferably by more than or equal to 7%, and particularly preferably by more than or equal to 9%, compared to previously known systems.

If the necessary electric energy is at least partially furthermore obtained by regenerative methods, the scope 2 CO₂ emission can be further reduced.

For this purpose, the apparatus for producing a metallic product can be electrically connected directly as well as for direct use of the provided energy to an associated wind farm and/or an associated photovoltaic plant and/or an associated bioenergy plant and/or a hydroenergy plant.

Scope 2 CO₂ emission can also be further reduced by an electrical connection to a nuclear power plant and the use of nuclear energy.

In a preferred embodiment, the apparatus comprises less than one static reactive power compensator for connection to a three-phase power system.

It has been found that by omitting a static reactive power compensator, the electrical energy demand associated with the operation of the apparatus for producing a metallic product can be reduced by greater than or equal to 1%, preferably by greater than or equal to 2%, and more preferably by greater than or equal to 3%.

Expediently, the electric arc furnace comprises a continuous charging device for continuously charging the electric arc furnace with the metallic raw material.

The following terms are explained in more detail:
A “continuous charging device” is understood as a means that is set up to continuously fill an electric arc furnace with metallic raw material.

Known electric arc furnaces are filled intermittently, where the electric arc furnace is loaded with a charge of metallic raw material, the metallic raw material is melted and the molten material is discharged before the next charge of metallic raw material can be loaded into the electric arc furnace.

The continuous charging device advantageously enables the melting process to take place more continuously compared to an electric are furnace without continuous charging, preferably since the charge mix is continuously fed and molten.

Through the continuous charging device, a flat bath operation of the electric arc furnace can be achieved, avoiding the need to open the electric arc furnace roof to fill the electric arc furnace using a bucket. With conventional electric arc furnaces that are filled via a bucket, each opening of the roof causes an energy loss of between 5 and 10 kwh/ton of the metallic product. Therefore, a scope 2 CO₂ emission reduction can be achieved by the continuous charging device.

The necessary electric energy consumption associated with the operation of the electric arc furnace and thus the scope 2 CO₂ emission can be reduced by more than or equal to 4% by using a continuous charging device, preferably by more than or equal to 5%, and particularly preferably by more than or equal to 6%.

Furthermore, a scope 1 CO₂ emission reduction can be achieved by the fact that the scope 1 CO₂ emitting consumption of the at least one electrode can be advantageously reduced by the flat bath operation of the electric arc furnace.

Due to the constant melting profile and a possible preferable combination of a continuous charging device with an automatic slag door, the carbon feed injected to the electric arc furnace can be reduced compared to a conventional electric arc furnace, again reducing the scope 1 CO₂ emission.

Furthermore, the continuous charging device can eliminate the need for a preheating system for the scrap. This can reduce the necessary carbon injection into the electric arc furnace compared to an electric arc furnace using a preheating system for the scrap, as no excess CO is needed for preheating. It should be remembered that the preheating of the scrap in a conventional electric arc furnace is done by post-combustion of CO to CO₂ and otherwise some excess CO is needed for this. Accordingly, this can again reduce the scope 1 CO₂ emission.

According to a preferred embodiment, the electric arc furnace comprises a hydrogen burner.

Here, it is proposed that the electric arc furnace comprises at least one hydrogen burner, the hydrogen burner being adapted to supply heat to a furnace vessel of the electric arc furnace from its outside. With this additional heat, the metallic raw material can also be melted and further heated.

By using hydrogen as a fuel to generate process heat, both the scope 1 CO₂ emission and the scope 2 CO₂ emission can be reduced.

The hydrogen can be obtained by steam electrolysis starting from the steam generated by the heat of the off-gases of the electric arc furnace.

Furthermore, it should be noted that the hydrogen can also be obtained by regenerative methods. In particular, the hydrogen can be produced by electrolysis using electrical energy from a wind farm, a biogas plant, a hydroelectric plant or a photovoltaic plant. Alternatively, energy from a nuclear power plant can be used to produce hydrogen.

By using an electric are furnace with a hydrogen burner it can be achieved that the sum of scope 1 CO₂ emissions and scope 2 CO₂ emissions of the apparatus for producing a metallic product can be reduced by more than or equal to 10 kg/ton of the metallic product, preferably by more than or equal to 12 kg/ton of the metallic product, and particularly preferably by more than or equal to 14 kg/ton of the metallic product.

In an optional embodiment, the electric arc furnace comprises an automatic slag door.

The following terms are explained in more detail:
An “automatic slag door” is a door of the electric arc furnace, which is set up to automatically control and/or to regulate the amount of slag floating on the bath of liquid metal within the electric arc furnace.

The automatic slag door can be set up to seal the electric arc furnace and/or regulate a slag flow, in particular a slag flow coming out of the furnace.

By sealing the electric arc furnace, the electric arc furnace can be operated with a higher slag layer, resulting in a longer arc and lower current associated with the longer arc. Since the scope 1 CO₂ emitting consumption of the at least one electrode is proportional to the current and the square of the current, lower current means lower electrode consumption, directly resulting in a lower scope 1 CO₂ emission.

At the same time, by means of automatic sealing of the electric arc furnace, a reduction in the loss of useful carbon and lime within the electric arc furnace can be achieved, thus the supply of carbon and lime needed for operation of the electric arc furnace can be reduced, which are injected into the electric arc furnace. This can again reduce the scope 1 CO₂ emission associated with the operation of the electric are furnace.

Thus, the scope 1 CO₂ emission can be reduced by the use of an automatic slag door, in particular by 0.5%, preferably by 1% and particularly preferably by 1.5%.

Simultaneously, a better slag foaming can be achieved by the automatic slag door, which can increase the energy efficiency of the electric arc furnace. In particular, energy losses in water-cooled panels of the electric arc furnace can be reduced, thereby reducing the demand for electrical energy. By this, the scope 2 CO₂ emission can be reduced, in particular by 0.5%, preferably by 1%and particularly preferably by 1.5%.

According to an expedient embodiment, the apparatus comprises a ladle and an electrical ladle preheating system, which is set up to preheat a ladle relinning, and/or an electrical ladle drying system, which is set up to dry the ladle relinning.

The following terms are explained in more detail:
An “electrical ladle dryer system” is to be understood as an electrical energy heated system for drying a relinning of the ladle, preferably the electrical ladle dryer system is being adapted to dry and heat the refractories of the ladle to a proper operational temperature.

An “electrical ladle preheating system” is to be understood as an electrical heating system for the relining of the ladle, preferably the system is being arranged to heat the refractories of the ladle to the designated temperature of operation.

In a known manner, heating and drying of the relining of the ladle is effected by burning a carbon-containing gas, so that a reduction of the scope 1 CO₂ emission can be achieved by the system proposed herein. Preferably, this can reduce the scope 1 CO₂ emission by more than or equal to 5 kg/ton of the metallic product, more preferably by more than or equal to 10 kg/ton of the metallic product, and most preferably by more than or equal to 15 kg/ton of the metallic product.

The apparatus can comprise a ladle and a hydrogen burner set up to warm the ladle relinning.

By using hydrogen as a fuel to generate process heat for the ladle, both the scope 1 CO₂ emission and the scope 2 CO₂ emission can be reduced. Among other things, it is possible to replace scope 1 CO₂ emission with scope 2 CO₂ emission.

Furthermore, it should be noted that the hydrogen can also be obtained by regenerative methods, which can also reduce the scope 2 CO₂ emission.

Preferably, the apparatus comprises a tundish and an electrical tundish dryer system, which is set up to dry a tundish relining, and/or an electrical tundish preheating system, which is set up to preheat the tundish relinning.

The following terms are explained in more detail:
An “electrical tundish dryer system” is to be understood as an electrical energy heated system for drying a relinning of the tundish, preferably the electrical tundish dryer system is being adapted to heat the tundish relining so that a residue of a metal alloy can be removed.

A reduction of scope 1 CO₂ emission regarding a tundish depends on the number of tundishes used in a year, which can be independent on the plant productivity. An apparatus for producing a metallic product can use one tundish every day of production, so that the energy requirement for preheating and/or drying can arise for every tundish used.

Preferably, a reduction of the scope 1 CO₂ emission by more than or equal to 0.5 kg/ton of the metallic product can be achieved by using an electrical tundish dryer system for every tundish used, more preferably by more than or equal to 1.0 kg/ton of the metallic product, and most preferably by more than or equal to 1.5 kg/ton of the metallic product.

An “electrical tundish preheating system” is to be understood as an electrical heating system for the relinning of the tundish, preferably the system is being arranged to heat the relinning of the tundish to the designated temperature of the molten metal.

Preferably, a reduction of the scope 1 CO₂ emission by more than or equal to 1.5 kg/ton of the metallic product can be achieved by using an electrical tundish preheating system for every tundish used, more preferably by more than or equal to 3.0 kg/ton of the metallic product, and most preferably by more than or equal to 4.5 kg/ton of the metallic product.

Overall, test data shows that with an electric tundish preheating system and with an electric tundish drying system, scope 1 CO₂ emission of more or equal to 100,000 kg/year can be saved, preferably by more than or equal to 110,000 kg/year and particularly preferably by more than or equal to 120,000 kg/year.

For an embodiment of an apparatus for producing a metallic product to produce 350,000 t/year, scope 1 CO₂ emission of more or equal to 0.25 kg/ton of the metallic product can be saved with an electric tundish preheating system and with an electric tundish drying system, preferably more or equal to 0.30 kg/ton and particularly preferably more or equal to 0.35 kg/ton.

For another embodiment of an apparatus for producing a metallic product to produce 500,000 t/year, scope 1 CO₂ emission of more or equal to 0.20 kg/ton of the metallic product can be saved with an electric tundish preheating system and with an electric tundish drying system, preferably more or equal to 0.22 kg/ton and particularly preferably more or equal to 0.24 kg/ton.

For another different embodiment of an apparatus for producing a metallic product to produce 700,000 t/year, scope 1 CO₂ emission of more or equal to 0.15 kg/ton of the metallic product can be saved with an electric tundish preheating system and with an electric tundish drying system, preferably more or equal to 0.16 kg/ton and particularly preferably more or equal to 0.17 kg/ton. The apparatus can comprise a tundish and a hydrogen burner set up to warm the tundish relinning.

By using hydrogen as a fuel to generate process heat for the tundish, both the scope 1 CO₂ emission and the scope 2 CO₂ emission can be reduced. Among other things, it is possible to replace scope 1 CO₂ emission with scope 2 CO₂ emission.

Furthermore, it should be noted that the hydrogen can also be obtained by regenerative methods, which can also reduce the scope 2 CO₂ emission.

According to a preferred embodiment, the apparatus being adapted to roll the billet strand directly in the rolling plant, wherein the apparatus is preferably being adapted to transfer the billet strand continuously from the continuous caster to the rolling plant, wherein the apparatus is preferably set up to roll the billet strand with first heat.

It is proposed here to roll the billet strand while making the best possible use of the first heat from the billet strand material. In other words, it is proposed not to first cut the billet strand into individual billets, to allow them to cool and to reheat them again for rolling, but to roll the billet strand directly and continuously after casting, with the billet strand running onto a first roll stand of the rolling plant at the casting speed. If necessary, the billet strand can be addition-ally heated before rolling. However, the objective of using the billet strand directly in the rolling plant is to make the best possible use of the first heat from the continuous casting process. Accordingly, the scope 1 CO₂ emission can be significantly reduced as a result. Preferably, the scope 1 CO₂ emission can be reduced by more than or equal to 15 kg/ton, preferably by more than or equal to 15 kg/ton and particularly preferably by more than or equal to 20 kg/ton.

In an optional embodiment, the apparatus comprises a billet strand preheating system for heating the billet strand to a preferred rolling temperature.

The following terms are explained in more detail:
A “billet strand preheating system” is understood to be a system which is set up to increase the temperature of the billet strand again advantageously before rolling, in particular for an area of the billet strand which was produced at a lower casting speed or for a very first billet used to calibrating the mill.

The billet strand preheating system can comprises an inductor and/or can consists of one or a plurality of inductors.

The following terms are explained in more detail:
An “inductor” is understood as a device comprising an electrically powered oscillating electric circuit adapted to generate a magnetic field which can be brought into an operative relationship with the billet strand so that the billet strand can be heated.

In this way, the use of a furnace for heating the billet strand upon combustion of a carbon-containing gas can be eliminated, thereby advantageously reducing scope 1 CO₂ emission.

According to a preferred embodiment, the preheating system is connected to a DC power supply, in particular a medium voltage DC power supply.

By electrically connecting the preheating system, in particular an inductor, to a DC power supply, in particular a DC power supply starting from a photovoltaic system, at least one rectifier can be saved, which on the one hand can reduce the investment costs and on the other hand saves the electrical losses of a rectifier, so that the scope 2 CO₂ emission can be reduced, in particular by more than or equal to 0.5%, preferably by more than or equal to 1.0% and particularly preferably by more than or equal to 1.5%.

Optional, the rolling plant is connected to a DC power supply, in particular a medium-voltage DC power supply.

According to a preferred embodiment, the apparatus is at least partially supplied with energy obtained by regenerative methods.

The following terms are explained in more detail:
A “regenerative method” is understood as a method for producing electrical energy from energy sources that are regenerative, in particular hydro energy, wind energy, bio energy and/or solar energy.

Preferably, the apparatus for producing a metallic product is supplied with electrical energy produced by regenerative methods at a rate of greater than or equal to 15%, preferably greater than or equal to 30%, and more preferably greater than or equal to 45%. Further Preferably, the apparatus for producing a metallic product is supplied with electrical energy produced by regenerative methods at a rate of greater than or equal to 60%, preferably greater than or equal to 75% and more preferably greater than or equal to 90%.

Preferably, the apparatus for producing a metallic product is directly connected via a power supply, in particular a three-phase AC power supply network and/or via a DC power supply, to a wind farm and/or a biogas plant and/or a hydroelectric power plant and/or a photovoltaic plant and can obtain the electrical energy from there.

The electric arc furnace proposed here for use within the apparatus eliminates the need to burn carbon-containing gases to heat the electric arc furnace, which can advantageously reduce the scope 1 CO₂ emission.

According to a second aspect of the invention, the task is solved by an use of an apparatus according to the first aspect of the invention for producing a metallic product.

It is understood that the advantages of an apparatus for producing a metallic product, in particular for producing a metallic long product, in particular for producing a metallic bar and/or a metallic wire, in particular a metallic product of an iron-based alloy, according to the first aspect of the invention, as described above, transfer directly to an use of an apparatus according to the first aspect of the invention for producing a metallic product.

It should be noted that the subject-matter of the second aspect can be advantageously combined with the subject-matter of the preceding aspect of the invention, either individually or cumulatively in any combination.

Further advantages, details and features of the present invention are explained in the description of the following embodiments, thereby;

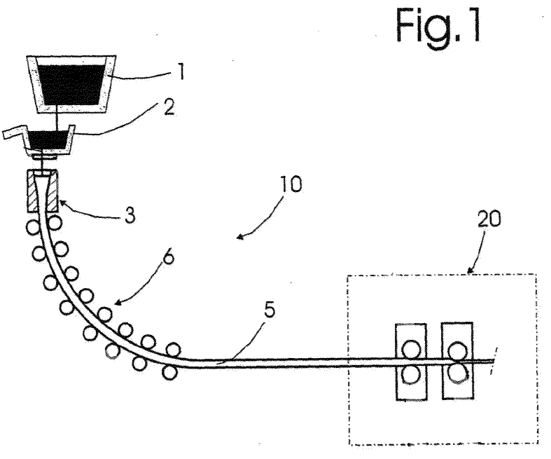

FIG. 1: shows a schematic view of an apparatus for producing a metallic product.

In the following description same reference numerals describe same elements and same features, respectively, so that a description of one element conducted with reference to one figure is also valid for the other figures, so that repetition of the respective feature is omitted.

The apparatus for producing a metallic product 10 in FIG. 1 consists essentially of a continuous caster 3, 6 comprising a mold 3 and a strand deflection device 6 for producing a billet strand 5 from molten metal (not marked) and a rolling plant 20 for forming the billet strand 5 into the metallic material.

The molten metal is produced from raw material (not depicted) within an electric are furnace (not depicted).

In particular, the apparatus 10 can be used for the production of long products made of metal.

The electric arc furnace can comprises an energy supply apparatus (not depicted) for supplying the electric arc furnace with electrical energy, wherein the energy supply apparatus can be connected to a three-phase power supply system (not depicted), wherein said energy supply apparatus can be connected to at least one anode (not depicted) and one cathode (not depicted) for supplying said electric arc furnace with a direct current, or to at least two electrodes for supplying said electric arc furnace with a alternating current and wherein the energy supply apparatus can comprise a phase-shifting transformer (not depicted) and a rectifier circuit (not depicted) In a alternative embodiment, the apparatus comprises a at least single phase power transformer which is connected to at least two electrodes. The energy supply apparatus can reduce the a sum of scope 1 CO₂ emissions and scope 2 CO₂ emissions of the apparatus 10.

Further reductions of scope 1 CO₂ emissions and/or scope 2 CO₂ emissions can be achieved, if the electric arc furnace is equipped with a continuous charging device (not depicted) and/or a hydrogen burner (not depicted) and/or an automatic slag door (not depicted).

The apparatus for producing a metallic product 10 further comprises a tundish 2 and a ladle 1.

Both, the ladle 1 and/or the tundish 2 can comprise an electric preheating system (not depicted) and/or an electric dryer system, which can each contribute to the reduction of scope 1 CO₂ emissions of the apparatus 10.

The apparatus 10 is adapted to roll the billet strand 5 directly in the rolling plant 20, wherein the apparatus 10 is preferably being adapted to transfer the billet strand 5 continuously from the continuous caster 3, 6 to the rolling plant 20, wherein the apparatus 10 is preferably set up to roll the billet strand 5 with first beat. This allows the apparatus for producing a metallic product 10 to achieve a significant reduction of scope 1 CO₂ emissions and/or scope 2 CO₂ emissions.

The apparatus 10 can further comprise a billet strand 5 preheating system for heating the billet strand 5 to a preferred rolling temperature, in particular a billet strand S preheating system (not depicted) having an inductor (not depicted) or multiple inductors (not depicted).

The preheating system and/or the rolling plant 20 could be adapted to be connected to a DC power supply to reduce scope 2 CO₂ emissions.

Preferably, the apparatus for producing a metallic product 10 is directly connected via a power supply (not depicted), in particular a three-phase AC power supply network (not depicted) and/or via a DC power supply (not depicted), to a wind farm (not depicted) and/or a biogas plant (not depicted) and/or a hydroelectric power plant (not depicted) and/or a photovoltaic plant (not depicted) and/or a nuclear plant and adapted to obtain the necessary electrical energy or at least a fraction of the necessary electrical energy from there. By this, the scope 2 CO₂ emissions of the apparatus for producing a metallic product 10 can be reduced.

### LIST OF REFERENCE NUMERALS

1 ladle
2 tundish
3 mold
5 billet strand
6 strand deflection device
10 apparatus for producing a metallic product
20 rolling plant

1. An apparatus for producing a metallic product, the apparatus comprising:
an electric arc furnace for producing a molten metal from a metallic raw material;
a continuous caster for producing a billet strand from the molten metal; and
a rolling plant for forming the billet strand into the metallic product; wherein the apparatus is set up to reduce a sum of scope 1 CO₂ emissions and scope 2 CO₂ emissions.

2. The apparatus according to claim 1, wherein the apparatus comprises a scope 1 CO₂ emission of less than or equal to 175 kg/ton of the metallic product.

3. The apparatus according to claim 1, wherein the apparatus comprises a scope 2 CO₂ emission of less than or equal to 160 kg/ton of the metallic product.

4. The apparatus according to claim 1, wherein
the electric arc furnace comprises an energy supply apparatus for supplying the electric arc furnace with electrical energy;
wherein the energy supply apparatus is connected to a three-phase power supply system;
wherein said energy supply apparatus being connected to at least one anode and one cathode for supplying said electric arc furnace with a direct current or to at least two electrodes for supplying said electric arc furnace with an alternating current; and
wherein the energy supply apparatus comprises a phase shifting transformer and a rectifier circuit.

5. The apparatus according to claim 1, wherein
the electric arc furnace comprises an energy supply apparatus for supplying the electric arc furnace with electrical energy;
wherein the energy supply apparatus is connected to a three-phase power supply system;
wherein said energy supply apparatus being connected to at least two electrodes for supplying said electric arc furnace with an alternating current; and
wherein the energy supply apparatus comprises at least one single phase power transformer.

6. The apparatus according claim 1, wherein the apparatus further comprises less than one static reactive power compensator for connection to a three-phase power system.

7. The apparatus according to claim 1, wherein the electric arc furnace comprises a continuous charging device for continuously charging the electric arc furnace with the metallic raw material.

8. The apparatus according to claim 1, wherein the electric arc furnace comprises a hydrogen burner.

9. The apparatus according to claim 1, wherein the electric arc furnace comprises an automatic slag door.

10. The apparatus according to claim 1, wherein the apparatus further comprises a ladle and an electrical ladle preheating system, which is set up to preheat a ladle relinning, and/or an electrical ladle drying system, which is set up to dry the ladle relinning.

11. The apparatus according to claim 1, wherein the apparatus further comprises a ladle and a hydrogen burner set up to warm a ladle relinning.

12. The apparatus according to claim 1, wherein the apparatus further comprises a tundish and an electrical tundish dryer system, which is set up to dry a tundish relining, and/or an electrical tundish preheating system, which is set up to preheat the tundish relinning.

13. The apparatus according to claim 1, wherein the apparatus further comprises a tundish and a hydrogen burner set up to warm a tundish relinning.

14. The apparatus according to claim 1, wherein the apparatus is adapted to roll the billet strand directly in the rolling plant, wherein the apparatus is adapted to transfer the billet strand continuously from the continuous caster to the rolling plant, and wherein the apparatus is set up to roll the billet strand with first heat.

15. The apparatus according to claim 1, wherein the apparatus further comprises a billet strand preheating system for heating the billet strand to a preferred rolling temperature.

16. Apparatus according to claim 15, wherein the billet strand preheating system comprises an inductor and/or a plurality of inductors.

17. The apparatus according to claim 15, wherein the billet strand preheating system is connected to a DC power supply.

18. The apparatus according to claim 1, wherein the rolling plant is connected to a DC power supply.

19. The apparatus according to claim 1, wherein the apparatus is at least partially supplied with energy obtained by regenerative methods.

20. (canceled)
